(19) United States
(12) Patent Application Publication
(10) Pub. No.: US 2008/0126264 A1
(43) Pub. Date: May 29, 2008

(54) SYSTEMS AND METHODS FOR PRICE OPTIMIZATION USING BUSINESS SEGMENTATION

(76) Inventors: Jens E. Tellefsen, Mountain View, CA (US); Jeffrey D. Johnson, San Francisco, CA (US)

Correspondence Address: KANG LIM, 3494 CAMINO TASSAJARA ROAD #436, DANVILLE, CA, 94506, US

(21) Appl. No.: 11/938,714

(22) Filed: Nov. 12, 2007

Related U.S. Application Data
(63) Continuation-in-part of application No. 11/415,877, filed on May 2, 2006.
(60) Provisional application No. 60/865,643, filed on Nov. 13, 2006.

(51) Int. Cl. G06F 17/00; H04L 9/00

(52) U.S. Cl. 705/80; 705/400

(57) ABSTRACT

The optimization of product prices using business segmentation is provided. The business is segmented into a plurality of selected segments, each including a subset of products. Segmenting utilizes fixed dimensions and variable dimensions. Pricing power and pricing risk is computed for each segment. Pricing power is an ability to alter pricing of the products within the segment. Pricing risk is a risk factor associated with an alteration to pricing of the products within the segment. Pricing objectives are generated for each segment by comparing the pricing power to the pricing risk of the segment. Prices are optimized using the pricing objectives. Prices are set based on optimized prices. Price lists and policies may be managed, including negotiating of prices based on optimized prices. Additionally, the entire system may be linked to an enterprise resource system.

### CROSS REFERENCE TO RELATED APPLICATIONS

This is a continuation-in-part of co-pending U.S. application Ser. No. 11/415,877 filed on May 2, 2006, entitled “Systems and Methods for Business to Business Price Modeling Using Price Elasticity Optimization”, which is hereby fully incorporated by reference.

This application claims priority of U.S. Provisional Patent Application Ser. No. 60/865,643 filed on Nov. 13, 2006, which is hereby fully incorporated by reference.

### BACKGROUND OF THE INVENTION

The present invention relates to price optimization systems. More particularly, the present invention relates to systems and methods of generating optimized prices using business segments. Optimized prices and price guidance are generated for each selected segment. A deal envelope is generated and used to guide price selection according to rules based on business policy parameters and overall business objectives. Business policy is used to determine business rules which guide the optimization.

Many businesses rely upon careful pricing in order to stay competitive and still realize a profit. Successful price setting may be the difference between a company's solvency and demise. Through proper pricing, market dominance may be obtained and held, even in very competitive markets.

There are major challenges in business to business (hereinafter “B2B”) markets which hinder the effectiveness of classical approaches to price optimization.

For instance, in B2B markets, a small number of customers represent the lion's share of the business. Managing the prices of these key customers is where most of the pricing opportunity lies. Also, B2B markets are renowned for being data-poor environments. Availability of large sets of accurate and complete historical sales data is scarce.

Furthermore, B2B markets are characterized by deal negotiations instead of non-negotiated sale prices (prevalent in business to consumer markets). There is no existing literature on optimization of negotiation terms and processes, neither at the product/segment level nor at the customer level.

Finally, B2B environments suffer from poor customer segmentation. Top-down price segmentation approaches are rarely the answer. Historical sales usually exhibit minor price changes for each customer. Furthermore, price bands within customer segments are often too large and customer behavior within each segment is non-homogeneous.

Product or segment price optimization relies heavily on the quality of the customer segmentation and the availability of accurate and complete sales data. In this context, price optimization makes sense only (i) when price behavior within each customer segment is homogeneous and (ii) in the presence of data-rich environments where companies' sales data and their competitors' prices are readily available. These conditions are met almost exclusively in business to consumer (hereinafter “B2C”) markets such as retail, and are rarely encountered in B2B markets.

On the other hand, customer price optimization relies heavily on the abundance of data regarding customers' past behavior and experience, including win/loss data and customer price sensitivity. Financial institutions have successfully applied customer price optimization in attributing and setting interest rates for credit lines, mortgages and credit cards. Here again, the aforementioned condition is met almost exclusively in B2C markets.

There are three major types of price optimization solutions in the B2B marketplace: revenue/yield management, price testing and highly customized optimization solutions.

Revenue/yield management approaches were initially developed in the airline context, and were later expanded to other applications such as hotel revenue management, car rentals, cruises and some telecom applications (e.g., bandwidth pricing). These approaches are exclusively concerned with perishable products (e.g., airline seats) and are not pricing optimization approaches per se.

Price testing approaches attempt to learn and model customer behavior dynamically by measuring customer reaction to price changes. While this approach has been applied rather successfully in B2C markets, where the benefits of price optimization outweigh the loss of a few customers, its application to B2B markets is questionable. No meaningful customer behavior can be modeled without sizable changes in customer prices (both price increases and decreases). In B2B markets, where a small fraction of customers represent a substantial fraction of the overall business, these sizable price-changing tests can have adverse impact on business. High prices can drive large customers away with potentially a significant loss of volume. Low prices on the other hand, even for short periods of time, can dramatically impact customer behavior, increase customers' price sensitivities and trigger a more strategic approach to purchasing from the customers' side.

Finally, in B2B markets, highly customized price optimization solutions have been proposed. These solutions have had mixed results. These highly customized price optimization solutions require significant consulting effort in order to address companies' unique situations including cost structure, customer and competitor behavior, and to develop optimization methods that are tailored to the type of pricing data that is available. Most of the suggested price changes from these solutions are not implemented. Even when they are implemented, these price changes tend not to stick. Furthermore, the maintenance of such pricing solutions usually requires a lot of effort. This effort includes substantial and expensive on-going consulting engagements with the pricing companies.

Traditionally, teams of marketing specialists, or the truly gifted businessperson, were needed to devise successful pricing schemes. Often such pricing suggestions were not competitive and too costly to generate.

With the advent of computers, automated pricing became a reality. However, such pricing schemes often did not have the desired level of utility, intuitiveness, and functionality as to be of any great improvement over more traditional methods of price setting. These solutions have failed primarily because of the lack of reliable price control and management systems. In fact, in B2B markets, reliable price control and management systems may be significantly more complex and more important than price optimization modules.

For the typical business, the above systems are still too inaccurate, unreliable, costly and intractable in order to be utilized effectively for price setting. Businesses, particularly those involving large product sets, would benefit greatly from the ability to have accurate and efficient price setting tools available that allows for accurate business segmentation.

Furthermore, instead of developing highly customized company-specific price optimization solutions, there remains a need for scalable and customizable price optimization solutions that vary by industry vertical.

In particular, in the context of business to business markets, effective price modeling and optimization schemes have been elusive given the scarcity of sales data and the relatively small pool of available customers. In this environment, it is important to include all available relevant data, including competitive behavior data, in order to develop robust price modeling and optimization schemes. It is also important to continuously loop back to update and calibrate the price modeling and optimization schemes with new sales data generated from deals consummated with the benefit of the instant price modeling and optimization schemes.

It is therefore apparent that an urgent need exists for an effective price control and management systems which provides for parameterization, calculation and deployment of optimized target prices and price guidance through analysis of risks and pricing power of business segments to calculate optimized target prices and price guidance, thereby enabling effective price modeling and optimization in the context of business to business markets.

### SUMMARY OF THE INVENTION

The present invention provides systems and methods of generating optimized prices using business segments. Optimized prices and price guidance are generated for each selected segment. Such a system is useful for business to business markets.

One advantage of the present invention is that a user may work without building or tuning custom models. The present invention enables a clear optimization process which delivers an optimization process that is transparent to the business user.

The optimization of product prices using business segmentation is useful in association with products. The business is segmented into a plurality of selected segments. Each segment includes a subset of products. Segmenting utilizes fixed dimensions and variable dimensions. Fixed dimensions include geography, sales region, market group, customer size, customer type, industry, and deal type. Variable dimensions include customer class, product class, and deal class. Product class includes measures and levels. Measures includes volume, revenue, profit, margin, net price, purchase frequency, discount rates, compliance rates and customer behavior, and levels include quality and status.

Pricing power is computed for each segment. The pricing power is an ability to alter pricing of the products within the segment. Pricing power includes analyzing price variance, win rates, price yields and competitor pricing.

Likewise, pricing risk is computed for each segment. The pricing risk is a risk factor associated with an alteration to pricing of the products within the segment. Pricing risk includes analyzing sales revenue, sales trend, price distribution and customer spend.

Pricing objectives are generated for each segment by comparing the pricing power to the pricing risk of the segment. This includes performing a matrix analysis of pricing power and pricing risk.

Prices are optimized using the pricing objectives. Prices are set based on optimized prices. Price lists and policies may be managed, including negotiating of prices based on optimized prices. Additionally, the entire system may be linked to an enterprise resource system.

These and other features of the present invention may be practiced alone or in any reasonable combination and will be discussed in more detail below in the detailed description of the invention and in conjunction with the following figures.

### BRIEF DESCRIPTION OF THE DRAWINGS

In order that the present invention may be more clearly ascertained, one embodiment will now be described, by way of example, with reference to the accompanying drawings, in which:

FIG. 1 shows a logical block diagram illustrating the system for price optimization using business segmentation in accordance with an embodiment of the present invention;

FIG. 2 shows a logical block diagram illustrating the segment selector in accordance with an embodiment of the present invention;

FIG. 3 shows a logical block diagram illustrating the segmentor in accordance with an embodiment of the present invention;

FIG. 4 shows a logical block diagram illustrating the pricing power engine in accordance with an embodiment of the present invention;

FIG. 5 shows a logical block diagram illustrating the risk power engine in accordance with an embodiment of the present invention;

FIG. 6 shows a flowchart illustrating a process for price optimization using business segmentation in accordance with an embodiment of the present invention;

FIG. 7 shows a simplified graphical representation illustrating a process for designating business segments in accordance with an embodiment of the present invention;

FIG. 8 shows a flowchart illustrating a process for receiving fixed dimensions in accordance with an embodiment of the present invention;

FIG. 9 shows a flowchart illustrating a process for receiving variable dimensions in accordance with an embodiment of the present invention;

FIG. 10 shows a flowchart illustrating a process for receiving product class data in accordance with an embodiment of the present invention;

FIG. 11 shows a flowchart illustrating a process for pricing power analysis in accordance with an embodiment of the present invention;

FIG. 12 shows a flowchart illustrating a process for pricing risk analysis in accordance with an embodiment of the present invention;

FIG. 13 shows a flowchart illustrating a process for applying pricing objectives to business segments in accordance with an embodiment of the present invention;

FIG. 14 shows a flowchart illustrating a process for pricing optimization in accordance with an embodiment of the present invention;

FIG. 15 is a flowchart illustrating a method for cleansing sales history data prior to its use in an optimization scheme in accordance with an embodiment of the instant invention;

FIG. 16 is a flowchart illustrating a method for generating a demand model for use in a business to business price optimization system in accordance with an embodiment of the instant invention;

FIG. 17 is a flowchart illustrating a method for providing deal win/loss classification data for use in a business to business price optimization system in accordance with an embodiment of the instant invention;

FIG. 18 is a flowchart illustrating a method for generating a demand model for use in a business to business price optimization system in accordance with an embodiment of the instant invention;

FIG. 19 is a flowchart illustrating a method for reconciling optimized prices optimized price guidance for use in a business to business price optimization system in accordance with an embodiment of the instant invention;

FIG. 20 is a flowchart illustrating a method for generating optimized prices for use in a business to business price optimization system in accordance with an embodiment of the instant invention;

FIG. 21 is a flowchart illustrating a method for using a Nash equilibrium computation in generating optimized prices for use in a business to business price optimization system in accordance with an embodiment of the instant invention;

FIG. 22 is a graphical diagram showing an exemplary matrix of pricing objectives according to pricing and risk powers in accordance with an embodiment of the instant invention;

FIG. 23 is a graphical representation illustrating an example of a segment price distribution in accordance with an embodiment of the present invention;

FIG. 24 is a graphical representation illustrating a process for applying pricing objectives to each segment including shaping the price distribution curve using pricing objectives in accordance with an embodiment of the present invention;

FIG. 25 is a simplified graphical representation illustrating a process for applying pricing objectives to each segment including plotting price percentile against pricing objectives in accordance with an embodiment of the present invention;

FIG. 26A is a graphical representation illustrating the ability to shape price distribution curves through eliminating low price deals in accordance with an embodiment of the present invention;

FIG. 26B is a graphical representation illustrating the ability to shape price distribution curves through increasing average sales price in accordance with an embodiment of the present invention; and

FIG. 26C is a graphical representation illustrating the ability to shape price distribution curves through reducing price variation in accordance with an embodiment of the present invention;

FIG. 27A illustrates a computer system, which forms part of a network and is suitable for implementing the system for price optimization using business segmentation of FIG. 1; and

FIG. 27B illustrates a block diagram of a computer system and network suitable for implementing the system for price optimization using business segmentation of FIG. 1.

### DETAILED DESCRIPTION

### I. System Over View

The present invention will now be described in detail with reference to several embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. The features and advantages of the present invention may be better understood with reference to the drawings and discussions that follow.

The present invention provides systems and methods for pricing processes including relating segmentation, pricing power, pricing risk, and pricing objectives to the calculation of optimized price guidance and deployment of guidance. Also disclosed is a novel method for the calculation of pricing power and risk for each segment; application of pricing objective to each segment; calculation of optimized price and deal envelope per segment; and deployment of optimized prices in the pricing process.

“Pricing Power”, or “Power”, indicates a business' ability to change prices. It is calculated using a combination of measures, including price variance (how much prices vary in a segment), price yield (invoice price as a percent of list price), percent of approval escalations and win ratios. In some embodiments, typical values for Price Power are high, med, and low. Of course, in some alternate embodiments, other scales for measuring Pricing Power may be utilized, such as a continuous graduated scale.

“Pricing Risk”, “Risk”, or “Risk Power”, indicates the business risk of changing prices. It may be calculated using another set of measures, including total sales (revenue), change in revenue (or quantity) and the price distribution (shape of the price band curve). In some embodiments, typical values for Pricing Risk are high, med, and low. Of course, like for Pricing Power, in some alternate embodiments other scales for measuring Pricing Risk may be utilized, such as a continuous graduated scale.

“Pricing Objective” may be used to guide the negotiated price in a business segment. In some embodiments, pricing objectives may be assigned to different combinations of pricing power and risk.

In some embodiments, pricing objectives are defined using percentile values, which is a simple yet powerful way to set consistent targets in a segment with varying prices. For example, a zero percentile may refer to the minimum price, 100 percentile may refer to the maximum price and 50 percentile may refer to the median price. A green line may be defined as the accumulative set of price points from zero to 100%.

Deal guidance contains pricing objective prices, which include target price, approval price(s) and floor prices for each product in a segment. It is calculated using the segments historical prices and the assigned pricing objective. In some embodiments, each pricing objective price (target, approval, and floor) may be defined as a percentile and when applied to a data set can be used to calculate price points. An optimizer calculates the optimal deal guidance prices for each segment using the calculated pricing power, risk and objective.

In some embodiments, the optimizer may output a list of target prices, approval prices and floor prices—one for each segment (and product.)

One value of the present optimizing solution is the ability to apply different objectives to each business segment to manipulate product demand curves in different ways by applying target, approval and floor prices at different levels.

A deal manager may guide sales representatives, using a number of analysis tools, to negotiate optimal prices.

Additionally, the system may calculate a score for each line item based on the deal guidance and calculated a weighted deal score. Either line score or deal score can be used for approval routing.

### II. System for Price Optimization Using Business Segmentation

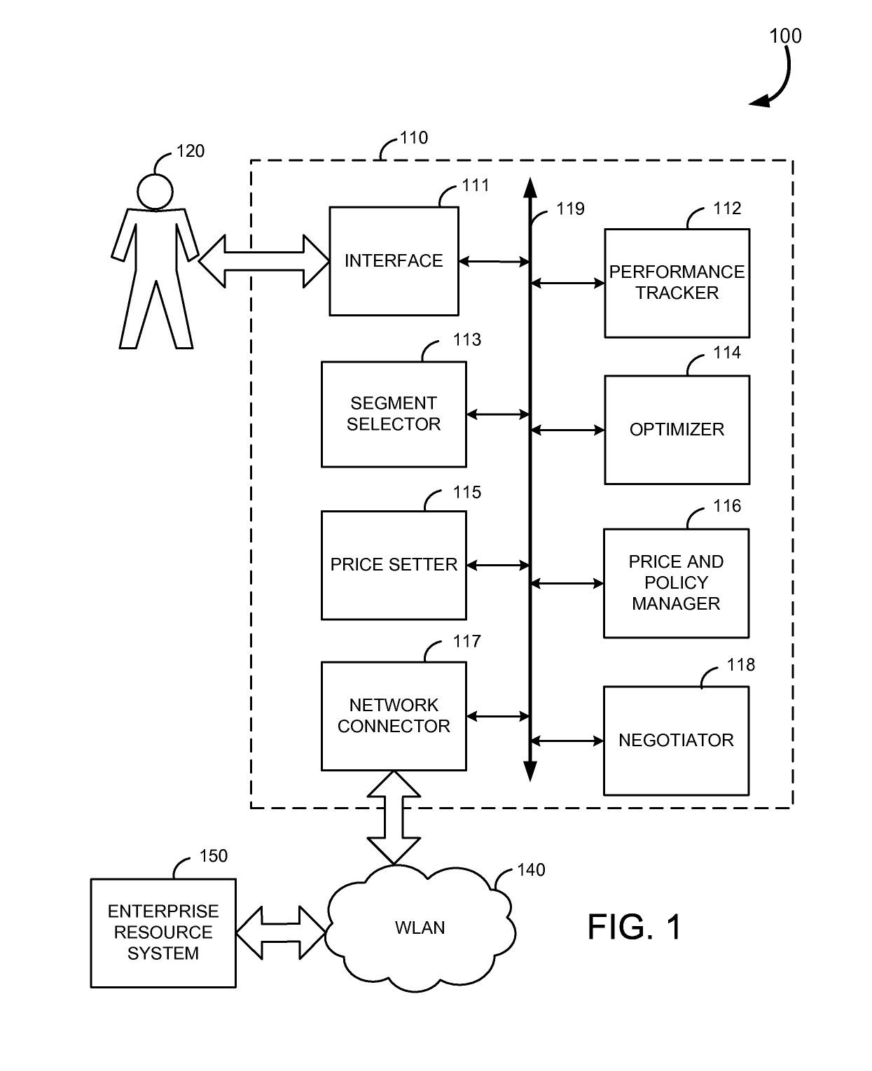

To facilitate discussion, FIG. 1 shows a logical block diagram illustrating the Price Optimization System with Business Segmentation 100 in accordance with an embodiment of the present invention. The Price Optimization System with Business Segmentation 100 includes a User 120 which may interact with a Pricing System 110. An Enterprise Resource System 150 may couple to the Pricing System 110 via a Wide Area Network, or WAN 140. The prototypical WAN 140 is the internet, however, additional WAN 140 may also be used, including, but not limited to a corporate network, or one or more Local Area Networks (LANs).

The User 120 may be a corporate officer, statistician, manager or other business planner. Alternatively, in some embodiments, User 120 may be an independent third party, such as a business planning consultant.

User 120 and Pricing System 110 may be located in a single location. Alternatively, in some embodiments, the Pricing System 110 may be accessed remotely by the User 120. Moreover, in some embodiments, the Pricing System 110 may be a diffuse system, capable of having components in various locations as required.

The Pricing System 110 may include an Interface 111, a Performance Tracker 112, a Segment Selector 113, an Optimizer 114, a Price Setter 115, a Price and Policy Manager 116, a Network Connector 117 and a Negotiator 118, each coupled to a Local Area Network 119. Of course this list of possible components is not exhaustive, and it is in the spirit of this application that additional or fewer components may be included as is desired for system functionality.

The Local Area Network 119 may provide interconnectivity between the components of Pricing System 110. In cases when the Pricing System 110 is located within a single unit, Local Area Network 119 may be a logical component. However, in some embodiments, when the components of the Pricing System 110 are diffusely located, Local Area Network 119 may include a corporate or other LAN, or WAN.

The Interface 111 may enable connectivity between the Pricing System 110 and the User 120. In some embodiments, the Interface 111 may enable the User 120 to configure the Pricing System 110, and view the output of the Pricing System 110.

The Performance Tracker 112 may track performance of the price setting and negotiated deals. Performance Tracker 112 may then provide feedback to the User 120. Additionally, the Performance Tracker 112 may, in some embodiments, provide feedback for fine tuning future pricing optimizations.

The Segment Selector 113 may define business segments. Such selection of business segments may include analyzing pricing risks and pricing powers. Business segments may include logical collections of products. Segment Selector 113 may provide the selected business segments to the Optimizer 114 for optimization. In some embodiments, the business segments may be dynamic, with products shifting from one business segment to another as is needed. For a typical business, 100s to 1000s of business segments may be identified. Of course, the system may function with any number of business segments.

In some embodiments, the Segment Selector 113 may additionally generate business objectives for each business segment. Segment Selector 113 may provide the selected business objectives to the Optimizer 114 for guiding optimization.

The Optimizer 114 may generate optimized pricing for the products within the business segment, relying upon the pricing objectives supplied by the Segment Selector 113. Such optimization may be performed utilizing statistical analysis, rule based approaches, Nash equilibrium, or any other suitable optimization method.

The Price Setter 115 may receive the optimization data from the Optimizer 114. The prices may then be set by the Price Setter 115. The Price Setter 115 may also deploy the set prices.

The Price and Policy Manager 116 may provide management of the products prices and deal negotiations. In some embodiments, the Price and Policy Manager 116 may be configured by the User 120.

The Network Connector 117 enables the Pricing System 110 to be coupled to the WAN 140. In some embodiments, Network Connector 117 may be a hardwire jack or a wireless enabled device.

The Negotiator 118 may provide guidelines and restrictions regarding deal negotiation to sales representatives based upon the prices and policies of the Price Setter 115 and Price and Policy Manager 116.

### III. Segment Selector

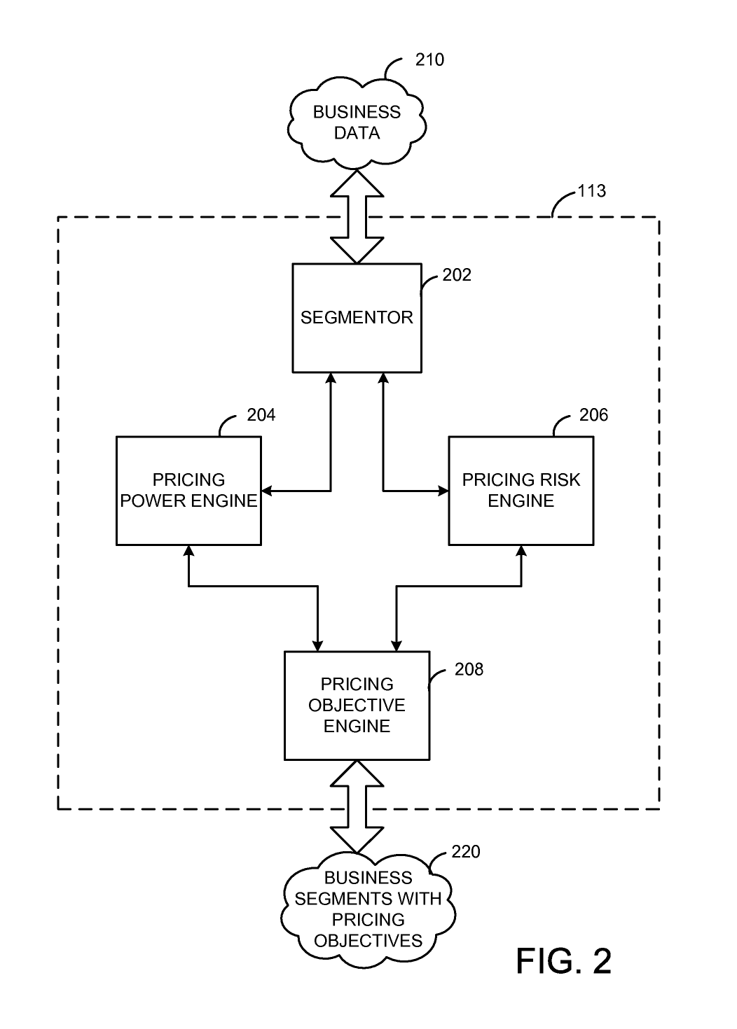

FIG. 2 shows a logical block diagram illustrating the Segment Selector 113 in accordance with an embodiment of the present invention. Segment Selector 113 includes a Segmentor 202, Pricing Power Engine 204, Pricing Risk Engine 206 and Pricing Objective Engine 208. The Segment Selector 113 receives input in the form of Business Data 210, and may output Business Segment with Pricing Objective Data 220. Segmentation is defined so as to group products and customers which can be expected to have sufficiently similar characteristics.

The Segment Selector 113 may receive Business Data 210. The Business Data 210 may be data from the User 120, the Price and Policy Manager 116, industry data, historic sales data and business data. The Business Data 210 may include information regarding the products and customers of the business. Business Data 210 may also include fixed dimensions and dynamic dimensions.

Business Data 210 may be received by a Segmentor 202. The Segmentor 202 may designate business segment and divide the products and customers into the business segment. Segmentor 202 may select business segment by utilizing the fixed dimensions and dynamic dimensions. Segmentor 202 may be coupled to the Pricing Power Engine 204 and the Pricing Risk Engine 206.

Each business segment may then be analyzed for pricing power and pricing risk by the Pricing Power Engine 204 and the Pricing Risk Engine 206, respectively. The Pricing Power Engine 204 and the Pricing Risk Engine 206 are each coupled to the Segmentor 202 and Pricing Objective Engine 208.

Results from the Pricing Power Engine 204 and Pricing Risk Engine 206 are received by the Pricing Objective Engine 208. The Pricing Objective Engine 208 may utilize the pricing power score and the pricing risk score for a given business segment to generate pricing objectives for the business segment. The business segment and pricing objectives are then output as the Business Segment with Pricing Objective Data 220.

### A. Business Segment Selection

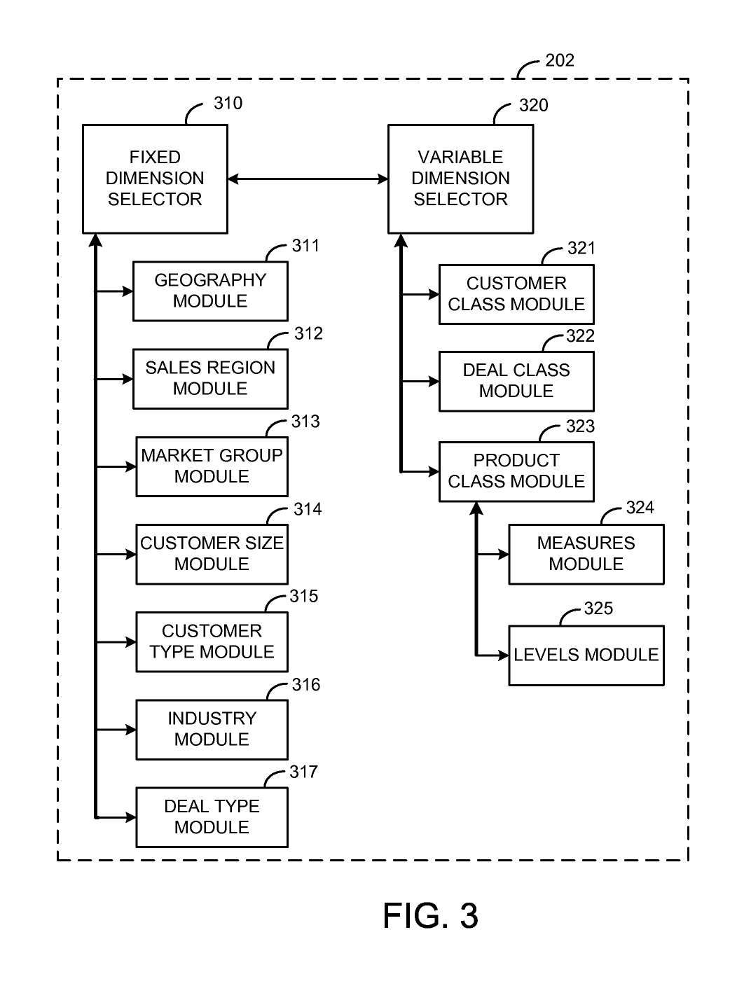

FIG. 3 shows a logical block diagram illustrating the Segmentor 202 in accordance with an embodiment of the present invention. The Segmentor 202 may include a Fixed Dimension Selector 310 and a Variable Dimension Selector 320. These two selectors may coordinate to generate the business segment.

The Fixed Dimension Selector 310 takes into account fixed dimensions in the generation of the business segments. The Fixed Dimension Selector 310 may include a Geography Module 311, a Sales Region Module 312, a Market Group Module 313, a Customer Size Module 314, a Customer Type Module 315, an Industry Module 316 and a Deal Type Module 317. Of course, additional or fewer modules may be included in the Fixed Dimension Selector 310 as is desired.

The Geography Module 311 may separate business segment by geography. The Sales Region Module 312 may separate business segment by sales regions. The Market Group Module 313 may separate business segment by market groups. The Customer Size Module 314 may separate business segment by customer size. The Customer Type Module 315 may separate business segment by customer type. The Industry Module 316 may separate business segment by industry type. The Deal Type Module 317 may separate business segment by deal type.

The Variable Dimension Selector 320 takes into account variable dimensions in the generation of the business segments. The Variable Dimension Selector 320 may include a Customer Class Module 321, a Deal Class Module 322, and a Product Class Module 323. Moreover, the Product Class Module 323 may include a Measures Module 324 and a Levels Module 325. Of course, additional or fewer modules may be included in the Variable Dimension Selector 320 as is desired.

The Customer Class Module 321 may separate business segment by customer class. The Deal Class Module 322 may separate business segment by deal class. The Product Class Module 323 may separate business segment by product class. In determining product class, the Measures Module 324 may separate business segment by product measures, and Levels Module 325 may separate business segment by product levels.

Product measures may include volume, revenue, profit, margin, net price, purchase frequency, discount rates, compliance rates and customer behavior to the product. Product levels may include quality and status levels. Of course, additional indices of product measure and level may be included as is desired.

### B. Pricing Power Analysis

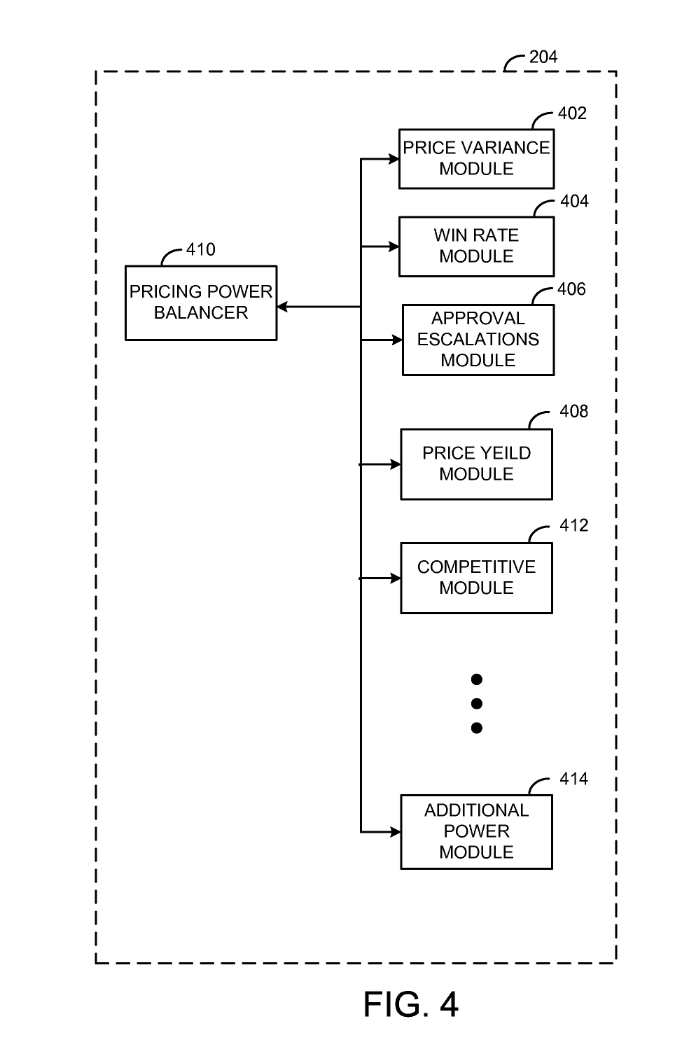

FIG. 4 shows a logical block diagram illustrating the Pricing Power Engine 204 in accordance with an embodiment of the present invention. The Pricing Power Engine 204 may include a Price Variance Module 402, a Win Rate Module 404, an Approval Escalations Module 406, a Price Yield Module 408, a Competitive Module 412, and an Additional Power Module 414 each coupled to a Pricing Power Balancer 410. Additional modules are contemplated, and are intended to be within the spirit of the present invention, as is indicated by the separation by the Competitive Module 412 and the Additional Power Module 414.

The Pricing Power Balancer 410 may receive input for the modules to generate a pricing power score. Said score may be generated on a continuous gradient. For example pricing power may be provided as any real number within a range. Alternatively, in some embodiments, pricing power score may be a more simple scale, such as “high”, “medium” or “low”.

The Price Variance Module 402 calculates the extent of the ability for a product price to diverge. The Win Rate Module 404 calculates the extent of the product win ratio. Win ratio may also be referred to as win probability, or win/loss. Win ratio indicates the probability of success of a deal under particular conditions. Win ratios may be represented as a curve of expected deal success probability as a function of price, promotion or other index. The Approval Escalations Module 406 calculates product approval escalations impact upon pricing power. The Price Yield Module 408 calculates product price yield impact upon pricing power. The Competitive Module 412 calculates the impact competition has upon pricing power. The Additional Power Module 414 provides for the consideration of any additional module that would assist in generating an accurate pricing power score.

Historic data and industry standard data may be utilized by the Price Variance Module 402, the Win Rate Module 404, the Approval Escalations Module 406 the Price Yield Module 408, the Competitive Module 412 and the Additional Power Module 414 in order to generate accurate indices of pricing power for the Pricing Power Balancer 410 to balance into a cohesive pricing power score.

### C. Pricing Risk Analysis

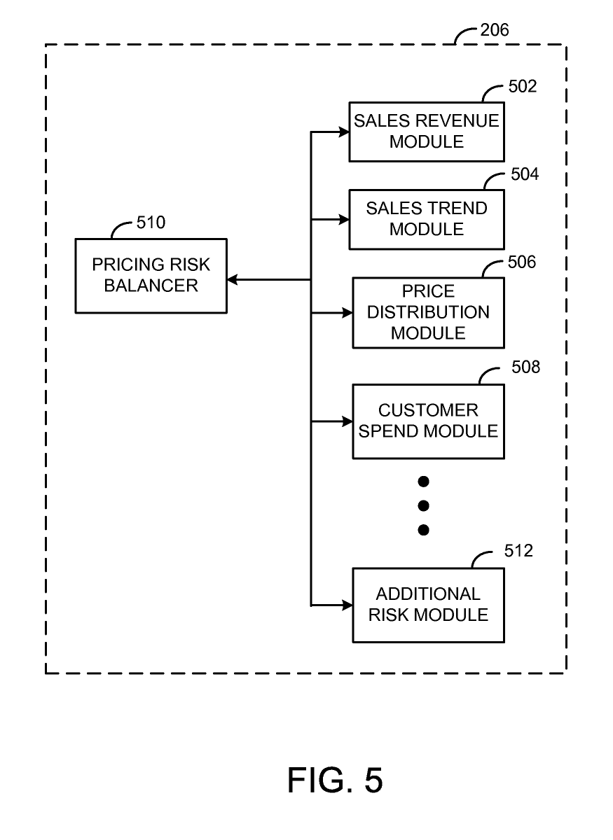

FIG. 5 shows a logical block diagram illustrating the Pricing Risk Engine 206 in accordance with an embodiment of the present invention. The Pricing Risk Engine 206 may include a Sales Revenue Module 502, a Sales Trend Module 504, a Price Distribution Module 506, a Customer Spend Module 508, and an Additional Risk Module 512 each coupled to a Pricing Risk Balancer 510. Additional modules are contemplated, and are intended to be within the spirit of the present invention, as is indicated by the separation by the Customer Spend Module 508 and the Additional Risk Module 512.

The Pricing Risk Balancer 510 may receive input for the modules to generate a pricing risk score. Said score may be generated on a continuous gradient. For example, pricing risk may be provided as any real number within a range. Alternatively, in some embodiments, pricing risk score may be a more simple scale, such as “high”, “medium” or “low”.

The Sales Revenue Module 502 calculates the sales revenue for a product. The Sales Trend Module 504 calculates the sales trend of the product. The Price Distribution Module 506 calculates product price distribution. The Customer Spend Module 508 calculates percent of total spend by the customer. The Additional Risk Module 512 provides for the consideration of any additional module that would assist in generating an accurate pricing risk score.

Historic data and industry standard data may be utilized by the Sales Revenue Module 502, the Sales Trend Module 504, the Price Distribution Module 506, the Customer Spend Module 508 and the Additional Risk Module 512 in order to generate accurate indices of pricing risk for the Pricing Risk Balancer 510 to balance into a cohesive risk score.

### IV. Process for Price Optimization Using Business Segmentation

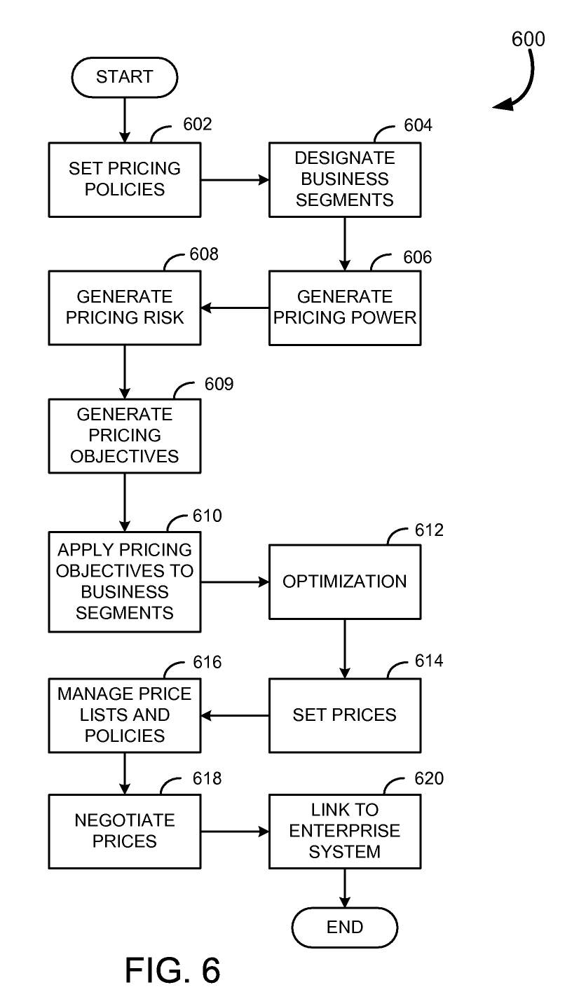

FIG. 6 shows a flowchart illustrating a process for price optimization using business segmentation, shown generally at 600. The process begins from step 602, where the User 120 sets pricing policies in the Price and Policy Manager 116. The process then proceeds to step 604 where business segments are designated by the Segmentor 202. Then, pricing power is generated as a pricing power score by the Pricing Power Engine 204 at step 606. At step 608, the pricing risk is generated as a risk score by the Pricing Risk Engine 206. The process then proceeds to step 609 where the pricing objectives are generated by the Pricing Objective Engine 208 by using the power score and risk score generated from steps 606 and 608, respectively. Then, at step 610, the pricing objectives are applied to the business segment. The process then proceeds to 612 where the optimization of prices is performed by the Optimizer 114. Prices are set at step 614 by the Price Setter 115. The process then proceeds to step 616 where pricing lists and policies are managed by the Price and Policy Manager 116 using the set prices and set policies from steps 614 and 602, respectively. The process then proceeds to step 618 where prices are negotiated. The Negotiator 118 may supply sales representatives with negotiation guidelines and requirements in order to facilitate the price negotiation. At the last step 620, the results of the price optimization may be linked to the Enterprise Resource System 150 via the Network Connector 117. The process then ends.

### A. Process of Segmenting

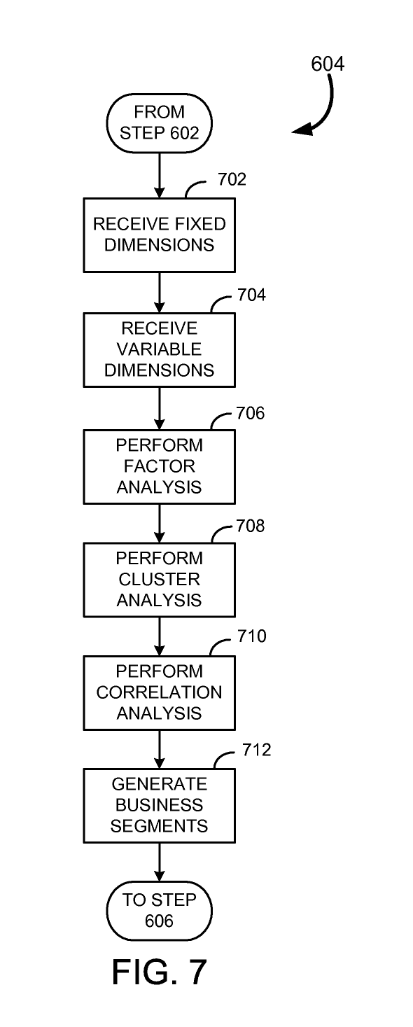

FIG. 7 shows a simplified graphical representation illustrating a process for designating business segments, shown generally at 604. The process begins from step 602 of FIG. 6. The process then proceeds to step 702 where fixed dimensions are received. Then at step 704 the variable dimensions are received. A factor analysis is performed at step 706 of the variable and fixed dimensions. Additionally, a cluster analysis is performed at step 708 of the variable and fixed dimensions. Also, at step 710, a correlation analysis is performed of the variable and fixed dimensions. Finally, at step 712 the business segments are generated by utilizing the results of the factor analysis, the cluster analysis and the correlation analysis. The process then concludes by progressing to step 606 of FIG. 6.

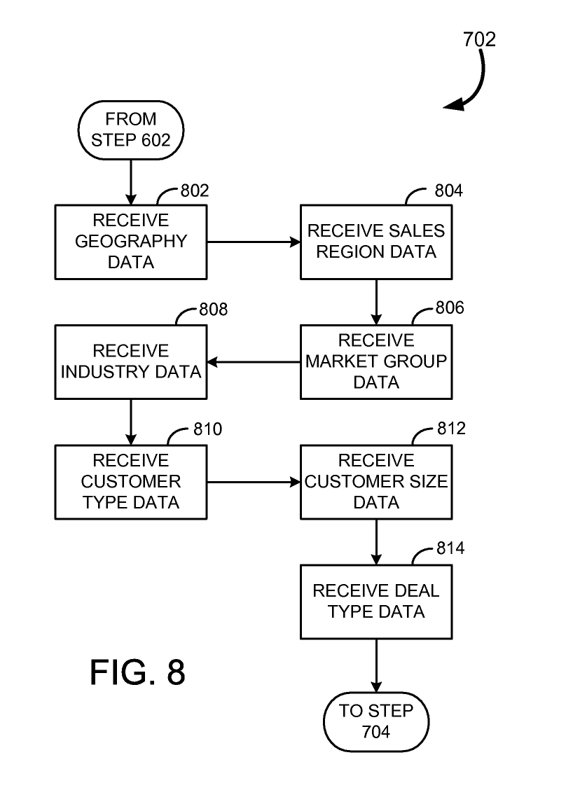

FIG. 8 shows a flowchart illustrating a process for receiving fixed dimensions, shown generally at 702. These fixed dimension data may be compiled by the Fixed Dimension Selector 310 for determination of business segment. The process begins from step 602 of FIG. 6. The process then proceeds to step 802 where geography data is received from the Geography Module 311. At step 804 sales region data is received from the Sales Region Module 312. Market group data is received from the Market Group Module 313 at step 806. Industry data may be received from the Industry Module 316 at step 808. Customer type data may be received from the Customer Type Module 315 at step 810. Customer size data may be received from the Customer Size Module 314 at step 812. Lastly, deal type data may be received from the Deal Type Module 317 at step 814. The process then concludes by progressing to step 704 of FIG. 7.

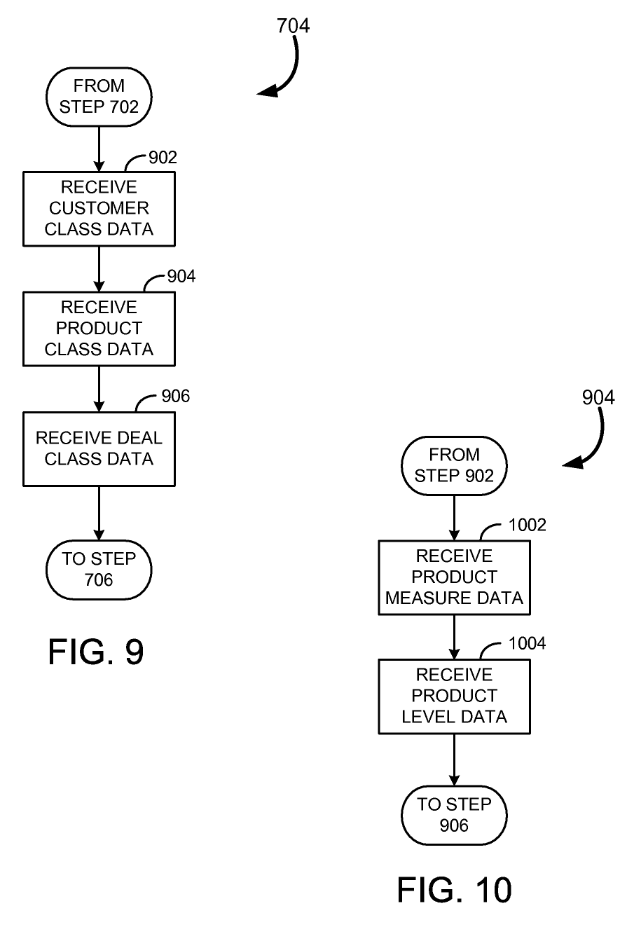

FIG. 9 shows a flowchart illustrating a process for receiving variable dimensions, shown generally at 704. These variable dimension data may be compiled by the Variable Dimension Selector 320 for determination of business segment. The process begins from step 702 of FIG. 7. The process then proceeds to step 902 where customer class data is received from the Customer Class Module 321. Product class data is received from the Product Class Module 323 at step 904. Deal class data may then be received from the Deal Class Module 322 at step 906. The process then concludes by progressing to step 706 of FIG. 7.

FIG. 10 shows a flowchart illustrating a process for receiving product class data, shown generally at 904. The product class data may be compiled by the Product Class Module 323 for usage as variable dimension data for determination of business segment. The process begins from step 902 of FIG. 9. The process then proceeds to step 1002 where product measure data is received by the Measures Module 324. Product measure data may include volume data, revenue data, profit data, margin data, net price data, purchase frequency data, discount rate data, compliance rate data and customer behavior data to the product. Product level data may be received from the Levels Module 325 at step 1004. Product level data may include quality data and status level data for the product. Of course, additional data types for product measure data and level data may be included as is desired. The process then concludes by progressing to step 906 of FIG. 9.

### B. Analyzing Pricing Power

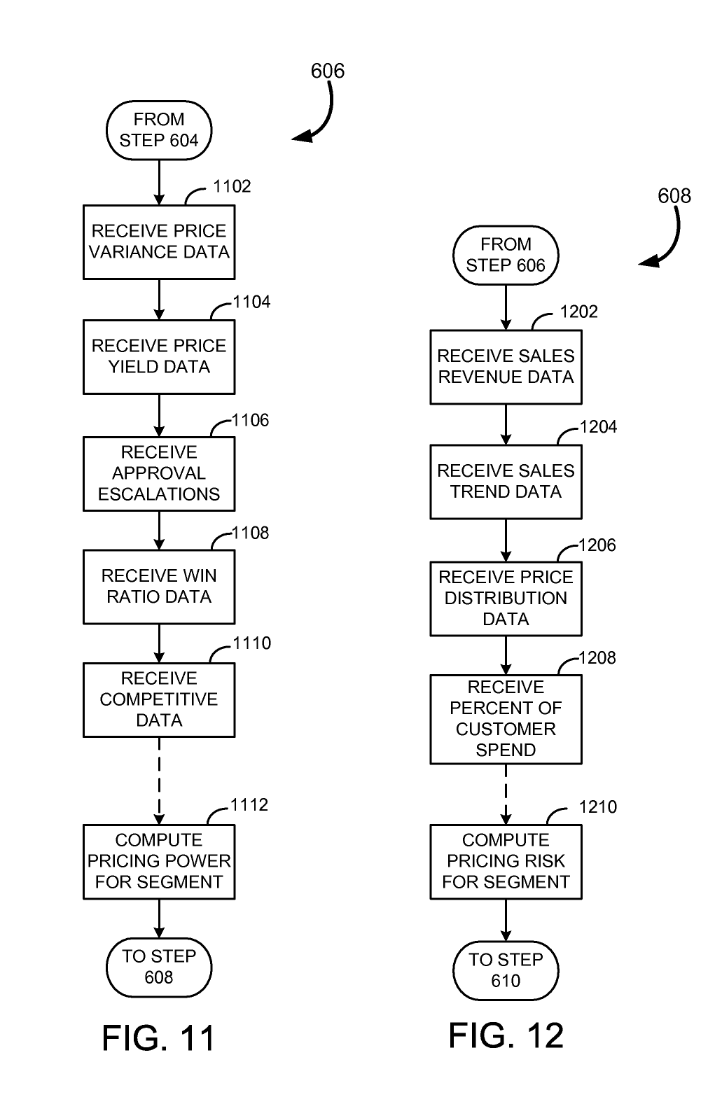

FIG. 11 shows a flowchart illustrating a process for pricing power analysis, shown generally at 606. The process begins from step 604 of FIG. 6. The process then proceeds to step 1102 where price variance data is received from the Price Variance Module 402. Price variance data is data on the variance of negotiated prices. Price yield data is received from the Price Yield Module 408 at step 1104. Price yield is the invoice price to list price ratio for a product. Approval Escalation data is received from the Approval Escalations Module 406 at step 1106. Approval Escalation data is the percent of deals escalated for approval. Win ratio data is received from the Win Rate Module 404 at step 1108. Win ratio may be expressed as a percent of deals won. At step 1110, competitive data may be received from the Competitive Module 412. Competitive data may include competitor's price position data.

Between step 1110 and 1112 additional pricing power data may be received from the Additional Power Module 414. An example of such data may include purchase frequency data of a customer.

The process then proceeds to step 1112 where pricing power for the business segment is computed by the Pricing Power Balancer 410 by balancing the received pricing power data. The Pricing Power Balancer 410 may generate a “score” or other indicia of the level of pricing power the given business segment has. As previously discussed, said score may be generated on a continuous gradient, or may be a more simple scale, such as “high”, “medium” or “low”. The process then concludes by progressing to step 608 of FIG. 6.

### C. Analyzing Pricing Risk

FIG. 12 shows a flowchart illustrating a process for pricing risk analysis, shown generally at 608. The process begins from step 606 of FIG. 6. The process then proceeds to step 1202 where total sales revenue data is received from the Sales Revenue Module 502. Sales trend data is received from the Sales Trend Module 504 at step 1204. Sales trend data includes changes in sales from a prior period. Price distribution data may be received from the Price Distribution Module 506 at step 1206. Price distribution data includes the distribution of prices, such as normal, left trailing, right trailing or even spread. Customer spend data may be received from the Customer Spend Module 508 at step 1208. Customer spend data includes the percent of customer's total spending which is being spent within the given business segment.

Between step 1208 and 1210 additional pricing risk data may be received from the Additional Risk Module 512. The process then proceeds to step 1210 where pricing risk for the business segment is computed by the Pricing Risk Balancer 510 by balancing the received pricing risk data. The Pricing Risk Balancer 510 may generate a “score” or other indicia of the level of pricing risk the given business segment has. As previously discussed, said score may be generated on a continuous gradient, or may be a more simple scale, such as “high”, “medium” or “low”. The process then concludes by progressing to step 610 of FIG. 6.

### D. Generating Pricing Objective

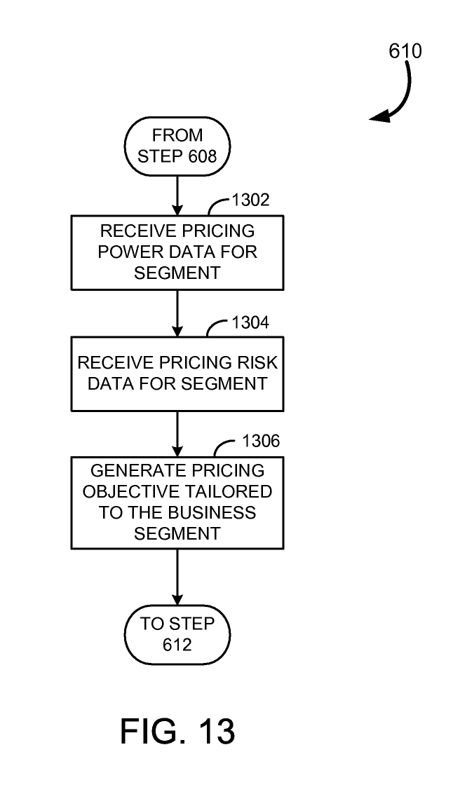

FIG. 13 shows a flowchart illustrating a process for applying pricing objectives to business segments, shown generally at 610. This process may be performed by the Pricing Objective Engine 208. The process begins from step 608 of FIG. 6. The process then proceeds to step 1302 where pricing power data for the business segment is received from the Pricing Power Engine 204. Received pricing power data may be in the form of a calculated pricing power score.

The process then proceeds to step 1304 where pricing risk data for the business segment is received from the Pricing Risk Engine 206. Like pricing power, received pricing risk data may be in the form of a calculated pricing risk score.

Lastly, at step 1306, pricing objective may be generated for the given business segment. Pricing objectives may, in some embodiments, be generated by comparing the pricing power score to the pricing risk score on a matrix. The intersection of any given power score to a risk score may then correspond to a particular pricing objective that is optimal for the given business segment.

In the case of continuous pricing power and risk scores, the Pricing Objective Engine 208 may utilize fuzzy logic in order to generate a pricing objective.

The process then concludes by progressing to step 612 of FIG. 6.

### E. Process of Pricing Optimization

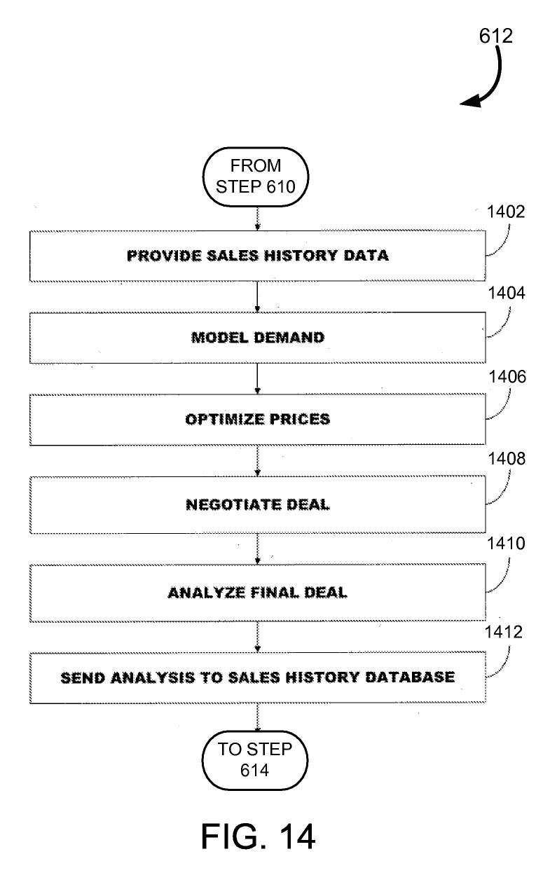

FIG. 14 shows a flowchart illustrating a process for pricing optimization, shown generally at 612. The process begins from step 610 of FIG. 6. The process then proceeds to step 1402 where sales history data is provided. Demand is modeled at step 1404. Prices are optimized at step 1406. A deal is negotiated at step 1408. The deal is analyzed at step 1410. Pertinent aspects of the deal analysis are sent back to the sales history database at step 1412. Each of these steps will be discussed in more detail below. The process then concludes by progressing to step 614 of FIG. 6.

Historical sales data is used by the demand modeling step 1404 to model demand for a selected product or segment. The demand modeling step 1404 is followed by the price optimization step 1406. The optimization step 1406 uses the demand models provided in generating a set of preferred prices for the selected product or business segment. The optimization step 1406 is followed by the deal negotiation step 1408, where the preferred prices may be used by a sales force in negotiating deals with customers.

A learning and calibration process follows the completion of the deal negotiations. The resulting deals, (i.e., quoted prices with customers) may be provided back as deal history data for iterative optimization. The learning and calibration process is carried out in steps 1410 and 1412. Information from the negotiated deals may be used in the learning and calibration process to update and calibrate the demand modeling and price optimization processes.

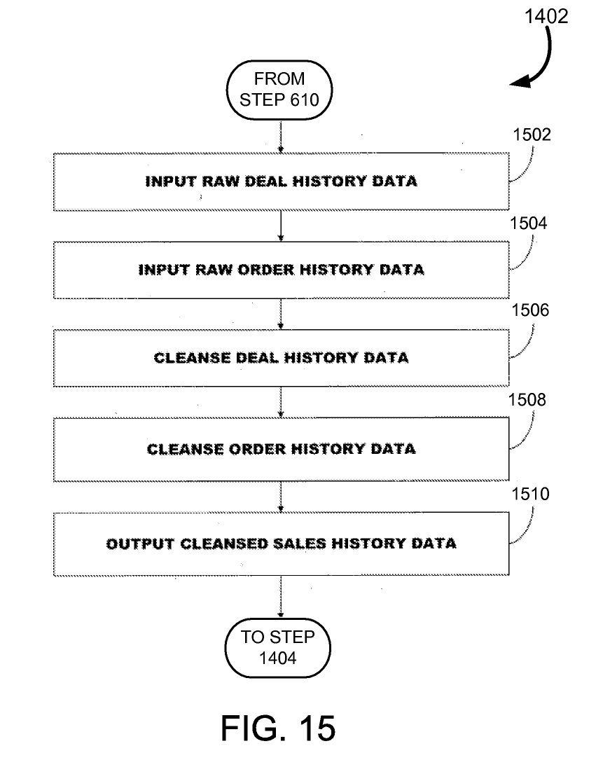

FIG. 15 is a flowchart illustrating a method for cleansing sales history data prior to its use in an optimization scheme, shown generally at 1402. The process begins from step 610 of FIG. 6. The process then proceeds to step 1502 where dataset creation and cleaning begins by inputting raw deal history data. Raw order history data is input at step 1504. The raw data is then subjected to cleansing at steps 1506 and 1508. Data cleansing includes accounting for missing or incompletes data sets as well as correcting or removing statistical outliers. For example, removing transactional outliers may include removing transaction data indicating sales dollars of zero or of an order of magnitude higher than a calculated average. Data cleansing may also include removing transactions with inconsistent data such as an order quantity of zero. Data cleansing may also include supplementing missing data with derived data. For example, missing region data may be set to a default region. The cleansed order history dataset is then output at step 1510. The process then concludes by progressing to step 1404 of FIG. 14 where the cleansed dataset is used in generating a demand model.

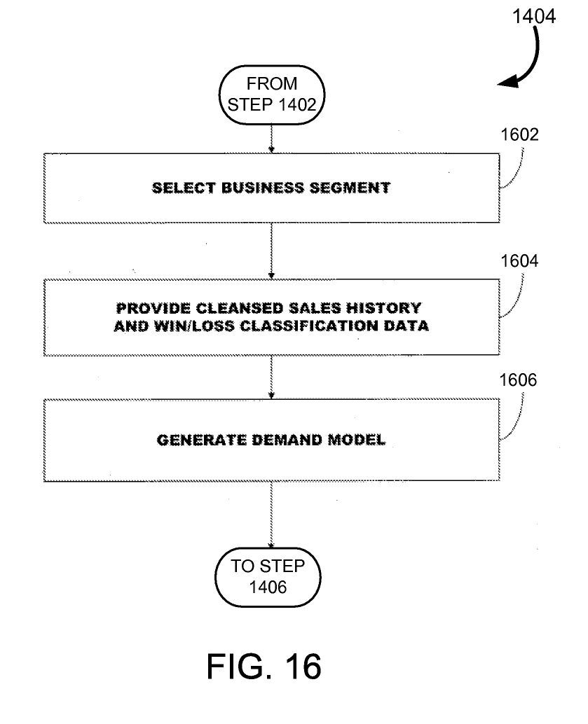

FIG. 16 is a flowchart illustrating a method for generating a demand model for use in a business to business price optimization system, shown generally at step 1404. The process begins from step 1402 of FIG. 14. The process then proceeds to step 1602 where the business segment is selected from the previously generated business segment from step 604. Sales history data for the selected product/segment is provided at 1604. In some embodiments, win/loss classification data, which defines a deal as a win or a loss based on comparison to the selected industry segment average net margin for the selected product/segment, is provided as well at 1604. Both, the sales history data and the win/loss classification data may be used to model demand at 1606. The process then concludes by progressing to step 1406 of FIG. 14.

Of course there are many ways of modeling demand functions, and it is intended that the present invention is flexible enough as to be able to utilize a variety of demand modeling methodologies as it becomes favorable to do so.

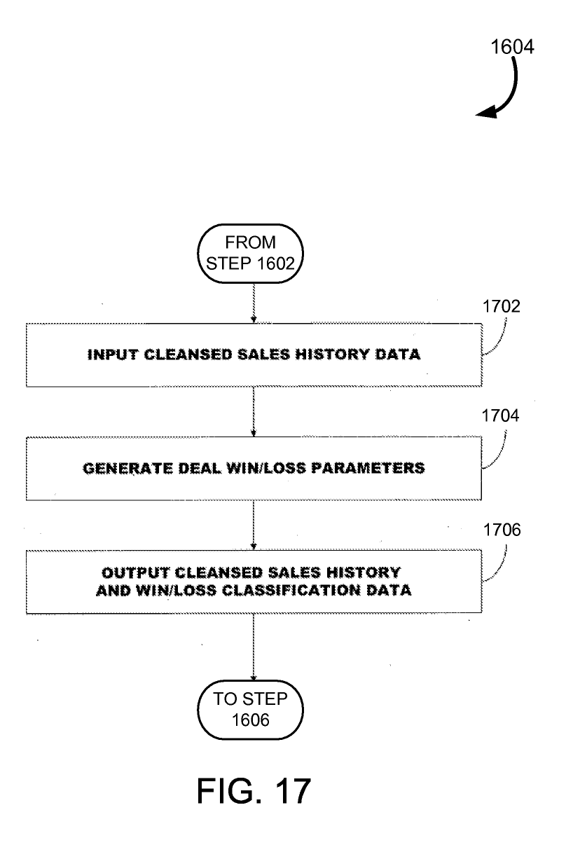

FIG. 17 is a flowchart illustrating a method for providing deal win/loss classification data for use in a business to business price optimization system, shown generally at step 1604. The process begins from step 1602 of FIG. 16. The process then proceeds to step 1702 where the cleansed order and deal history dataset is input. The data is used to generate deal win/loss parameters at step 1704. Deal win/loss data may be used to tune the ultimate price optimization process to account for real world results given optimized price sets.

Deals are classified as wins or losses based upon a comparison between deal transactions (quotes and/or contracts) and order transactions. The matching logic compares things like deal effective date (from and to date), specific product or product group, customer account, and ship-to or billed-to. Deal win/loss classification data may be output at step 1706. The process then concludes by progressing to step 1606 of FIG. 16 where the output win ratio data may be used to help model demand.

In some embodiments, demand for a particular product/segment is estimated using the cleansed datasets discussed above to generate a price elasticity demand model and a win probability model. A demand model is selected which fits well statistically with the historical data. For example, any of the commonly used, externally derived, multivariate, parametric, non-separable algorithms may be used to create the price elasticity and win probability models. The model which best fits the historical data may be used.

The price optimization may be performed using the optimized business segment scheme discussed above. In order to decide which algorithm to use or give the best fit, the optimization may run all of them and selects the best algorithm, i.e. the one that has the highest statistical significance vis-à-vis the cleansed data set. All of the algorithms provided by the User 120 may be included to find the best fit given the actual data. The User 120 may use any of the commonly used algorithms discussed above and/or the User 120 may provide preferred models based on the particular dataset in question.

Output from the demand model to the optimization model may be a set of price elasticity curves and optionally a set of win probability curves. One embodiment of the instant optimization model selects the demand model which best fits the cleansed data as discussed above. Game theory may be used to model competitive behavior based on historical data. One embodiment of the instant optimization combines game theory with dynamic non-linear optimization to give optimized prices. The optimization may be performed subject to optimization goals and constraints provided by Price and Policy Manager 116. For instance, the goal may be to optimize pocket margin given a limited change in product volume or product price.

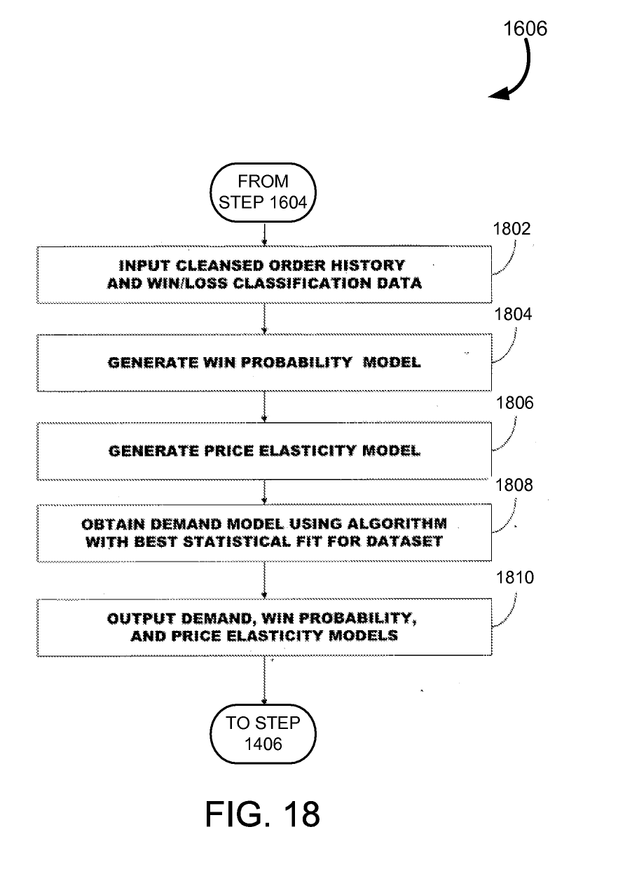

FIG. 18 is a flowchart illustrating a method for generating a demand model for use in a business to business price optimization system, shown generally at step 1606. The process begins from step 1604 of FIG. 16. The process then proceeds to step 1802 where cleansed order history data and win/loss classification data is provided. By using the algorithms discussed above, first a win probability model may be generated at step 1804. Next, a price elasticity model is generated at step 1806. The combined models are used to generate a demand model at step 1808. The models are output to the price optimization at step 1810. The process then concludes by progressing to step 1406 of FIG. 14.

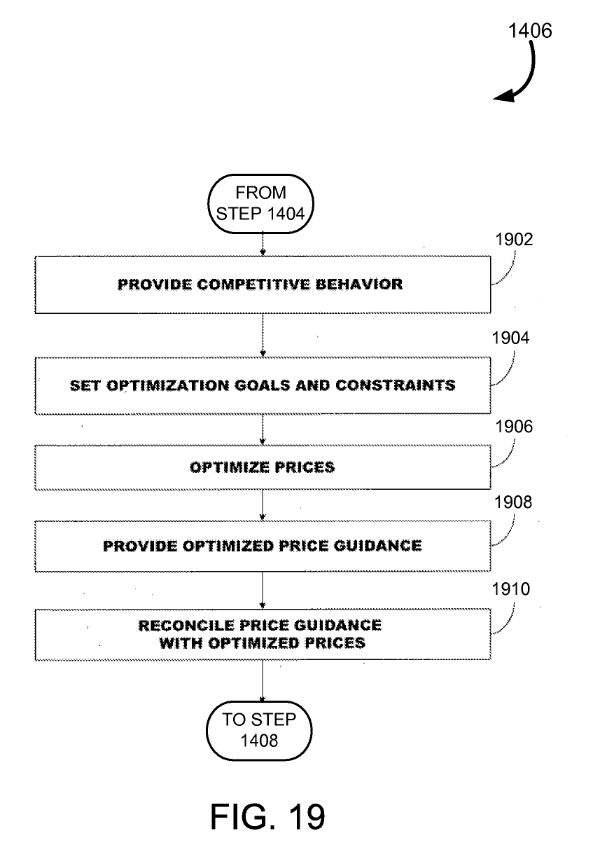

FIG. 19 is a flowchart illustrating a method for reconciling optimized prices optimized price guidance for use in a business to business price optimization system, shown generally at step 1406. The process begins from step 1404 of FIG. 14. The process then proceeds to step 1902 where competitive behavior is provided.

In some embodiments, it may also be important to provide optimization goals and constraints in any optimization scheme. The User 120 may decide to optimize for profit, sales or volume maximization. Once the optimization goal is selected, optimization constraints may be set. The User 120 may set the constraints in conformance with the particular business objectives as discussed above.

The User 120 may choose to constrain the following factors: maximum price increase, maximum price decrease for a business segment (e.g., Product Yearly Revenue Segment A) or intersection of business segments (e.g., Product Yearly Revenue Segment A and Biotech Industry Customers).

Optimization goals and constraints are provided at step 1904. Competitive behavior data along with selected optimization goals and constraints are used to optimize prices at step 1906. Previously generated and optimized pricing guidance is provided at step 1908. The optimized prices are reconciled with the optimized pricing guidance at step 1910. The process then concludes by progressing to step 1408 of FIG. 14 where reconciliation data is provided to for the deal negotiation.

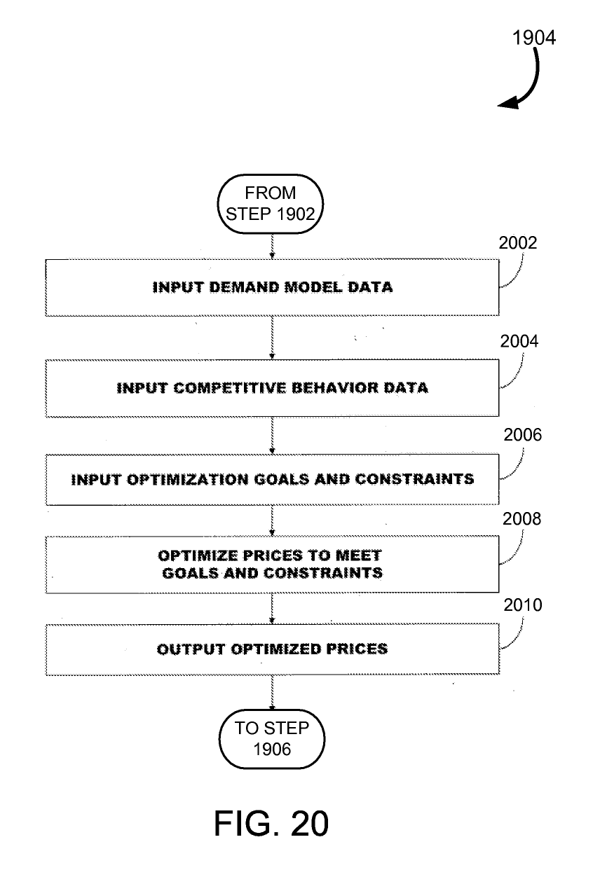

FIG. 20 is a flowchart illustrating a method for generating optimized prices for use in a business to business price optimization system, shown generally at step 1904. The process begins from step 1902 of FIG. 19. The process then proceeds to step 2002 where the demand model data is provided from the demand modeling step 1404. Competitive behavior data and optimization goals and constraints are provided at steps 2004 and 2006, respectively. Prices are optimized to meet the selected goals and constraints at step 2008. Finally, optimized prices are output for reconciliation at step 2010. The process then concludes by progressing to step 1906 of FIG. 19.

The resulting optimized, reconciled prices may be used in deal negotiations. The resulting deals, (i.e., quoted prices with customers) may be provided back as deal history data for iterative optimization. This continuous learning and calibration is done in order to fine tune the instant optimization process with real world data reflecting the actual results of incorporating the optimized prices into the deal negotiation process.

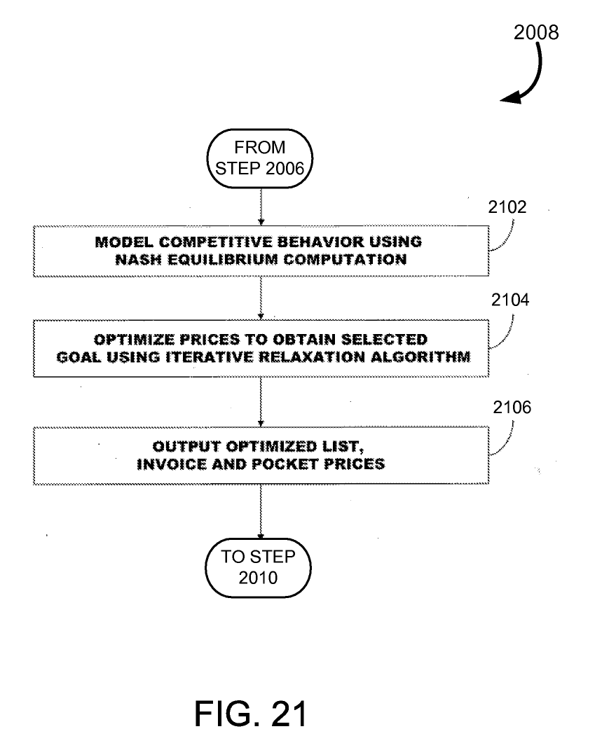

FIG. 21 is a flowchart illustrating a method for using a Nash equilibrium computation in generating optimized prices for use in a business to business price optimization system, shown generally at step 2008. The process begins from step 2006 of FIG. 20. The process then proceeds to step 2102 where competitive behavior is modeled using fictitious play and Nash equilibrium computation. Accurate prediction of competitive behavior is especially important in a B2B environment given the relatively small number of major customers.

Next, at step 2104, a dynamic, non-linear optimization may be conducted using an iterative relaxation algorithm. The Nash equilibrium computation may be combined with the selected non-linear optimization model to give optimized prices subject to optimization goals and constraints. Optimized prices are output at step 2106. The process then concludes by progressing to step 2010 of FIG. 20.

### V. Examples

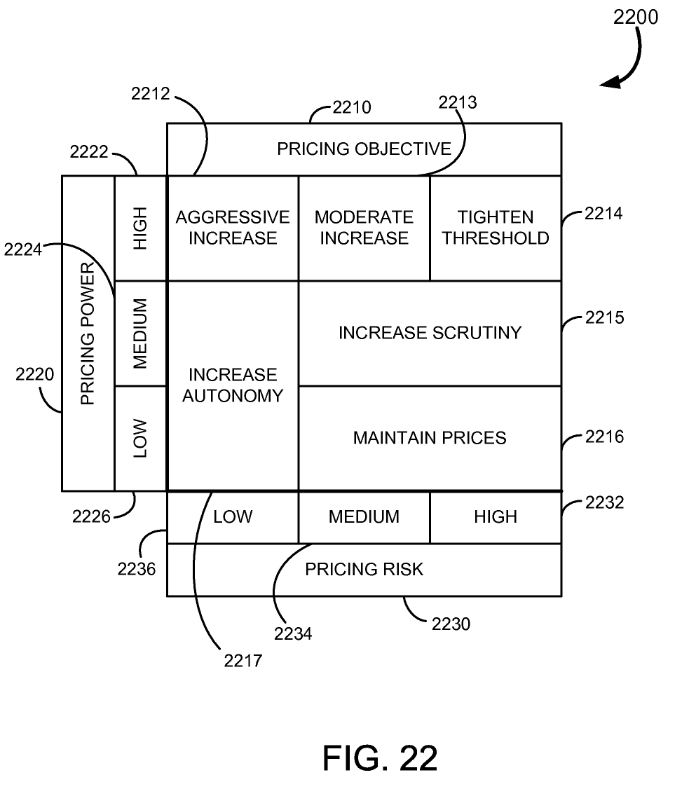

FIG. 22 is a graphical diagram showing an exemplary Matrix 2200 of pricing objectives according to pricing and risk powers in accordance with an embodiment of the instant invention. This Matrix 2200 is entirely exemplary in nature to illustrate how pricing power and pricing risks may be cross referenced in order to generate a pricing objective. This Matrix 2200 is useful for simple scores of pricing power and pricing risk that are one of three categories: “low”, “medium” and “high”.

Pricing Power Header 2220 is shown. High Power Score 2222, Medium Power Score 2224 and Low Power Score 2226 are located under the Pricing Power Header 2220. High Power Score 2222 would indicate that the business segment has the ability to be priced aggressively. Medium Power Score 2224 indicates pricing of a business segment may be subject to some pricing changes. Low Power Score 2226, on the other hand, indicates that a business segment is capable of little pricing changes.

Likewise, Pricing Risk Header 2230 may be seen with High Risk Score 2232, Medium Risk Score 2234, and Low Risk Score 2236. High Risk Score 2232 would indicate that the business segment would be subject to a great amount of risk when there are pricing changes. Medium Risk Score 2234 indicates pricing of a business segment would be subject to some amount of risk. Low Power Score 2226, on the other hand, indicates that a business segment would be subject to a small amount of risk when there are pricing changes.

By comparing the level of power of a business segment to its pricing risk the pricing objectives may be determined. Pricing Objective 2210 may be seen. When the business segment has a High Power Score 2222 and a Low Risk Score 2236, the pricing objectives may include Aggressive Increase of Pricing 2212. Aggressive Increase of Pricing 2212 may include increasing all levels of the business segment substantially in order to capitalize on the business' strong pricing situation.

Likewise, when the business segment has a High Power Score 2222 and a Medium Risk Score 2234, the pricing objectives may include Moderate Increase of Pricing 2213. Moderate Increase of Pricing 2213 may include increasing all levels of the business segment moderately in order to capitalize on the business' moderate pricing situation.

Also, when the business segment has a High Power Score 2222 and a High Risk Score 2232, the pricing objectives may include Tighten Pricing Threshold 2214. Tighten Pricing Threshold 2214 may include narrowing the gap between target and floor levels. When the business segment has a Medium Power Score 2224 and either a Medium Risk Score 2234 or High Risk Score 2232, the pricing objectives may include Increase in Pricing Scrutiny 2215. Increase in Pricing Scrutiny 2215 may include the increase of approval levels. Contrary, when the business segment has a Medium Power Score 2224 or Low Power Score 2226 and a Low Risk Score 2236, the pricing objectives may include Increase in Pricing Autonomy 2217. Increase in Pricing Autonomy 2217 may include the reduction of approval levels. Lastly, when the business segment has a Low Power Score 2226 and either a Medium Risk Score 2234 or High Risk Score 2232, the pricing objectives may include Maintain Pricing 2216.

In the embodiments that include continuous scores for pricing power and pricing risk, such the pricing objectives selection will be less strictly defined. In these embodiments, a graduated set of pricing objectives may be more appropriate. Alternatively, fuzzy logic principles may be utilized in order to generate the appropriate pricing objectives.

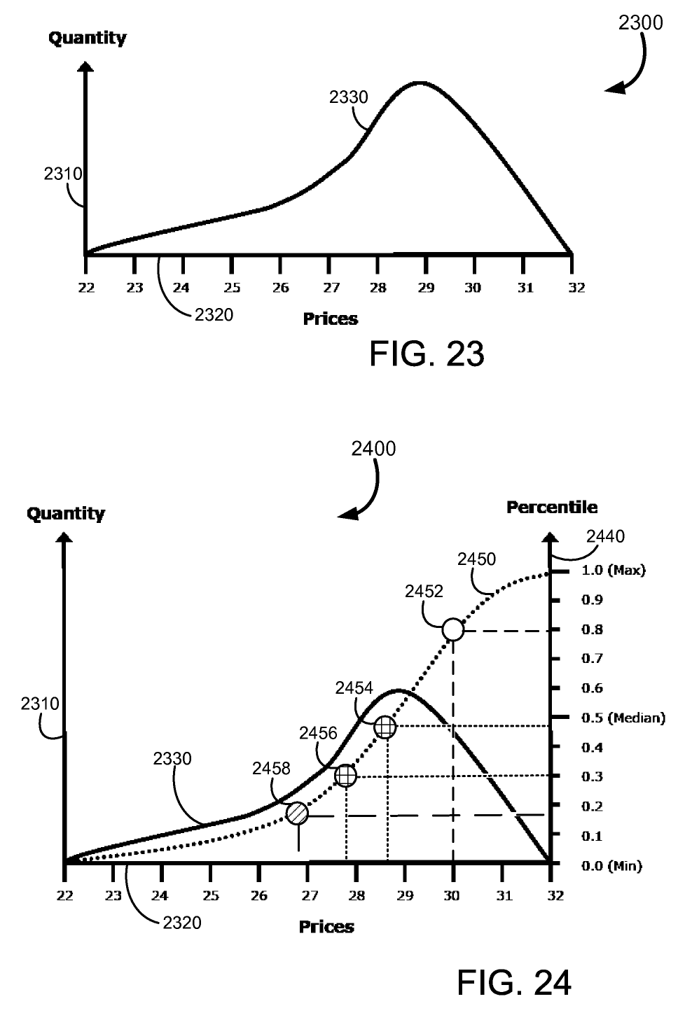

FIG. 23 is a graphical representation illustrating an example of a segment price distribution graph, shown generally at 2300. A Sale Quantity Axis 2310 may indicate the quantity of product sales. A Pricing Axis 2320 may indicate the price that the products were sold at. A Historic Product Demand Curve 2330 indicates what volume of sales resulted from a given price for a product given historically sales data.

FIG. 24 is a graphical representation illustrating a process for applying pricing objectives to each segment including shaping the price distribution curve using pricing objectives, shown generally at 2400. The Sale Quantity Axis 2310, Pricing Axis 2320 and Historic Product Demand Curve 2330 may still be seen. Additionally, a Pricing Percentile Axis 2440 is illustrated. The Pricing Percentile Axis 2440 may indicate the price percentile of the pricing objectives. Zero percentile refers to the minimum price, 100 percentile refers to the maximum price and 50 percentile refers to the median price. Each pricing objective price (Target Price 2452, First Approval Price 2454, Second Approval Price 2456, and Floor Price 2458) is defined as a percentile, and when applied to a data set can be used to calculate price points. The specific pricing objectives may correspond to a Pricing Objective Curve 2450. Thus, with varying Pricing Objective Curve 2450 the requirements for the Target Price 2452, First Approval Price 2454, Second Approval Price 2456 and Floor Price 2458 will vary.

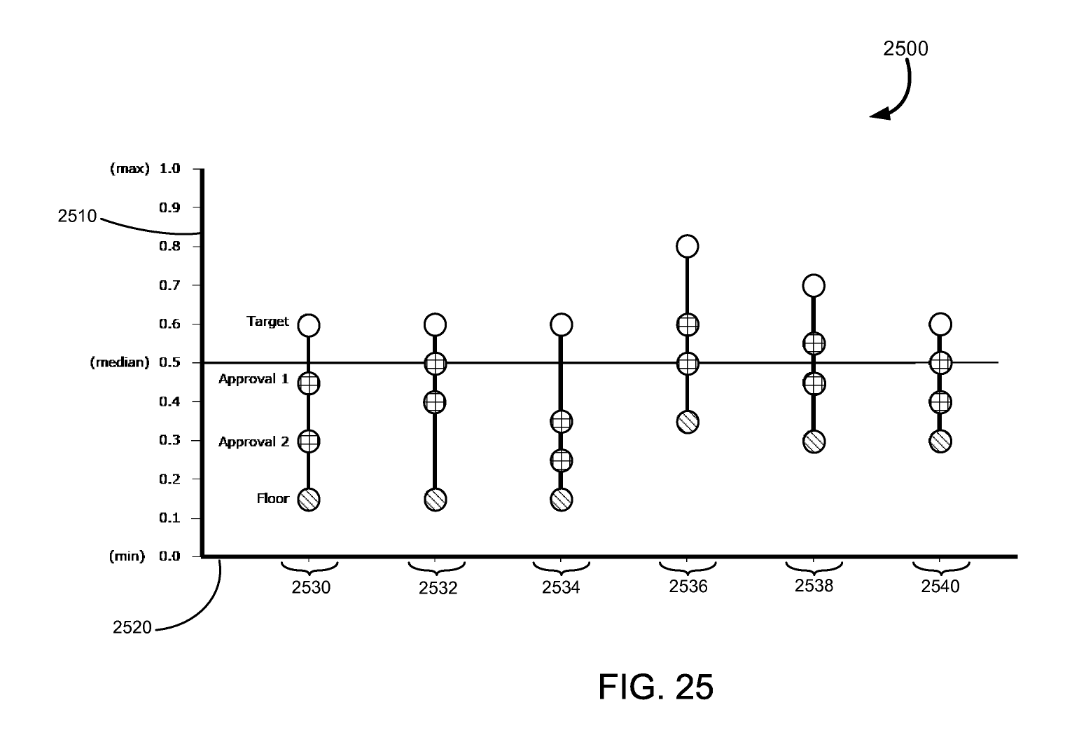

FIG. 25 is a simplified graphical representation illustrating a process for applying pricing objectives to each segment including plotting price percentile against pricing objectives, shown generally at 2500. This diagram is intended to be exemplary in nature to illustrate typical pricing objectives scenarios. A Price Percentile Axis 2510 indicates the price percentile of the pricing objectives. Zero percentile refers to the minimum price, 100 percentile refers to the maximum price and 50 percentile refers to the median price. Along Pricing Objective Example Axis 2520 are the various exemplary pricing objectives. Default Guidance 2530 indicates target, approval and floor price guidelines for maintenance of prices. Default Guidance 2530 typically occurs when the business segment has a low level of pricing power and also is subject to medium to high pricing risk.

Increase Scrutiny 2532 indicates when the approval levels are increased. Increase Scrutiny 2532 typically occurs when the business segment has a medium level of pricing power but also is subject to medium to high pricing risk.

Increase Autonomy 2534 indicates when the approval levels are reduced. Increase Autonomy 2534 typically occurs when the business segment has a low to medium level of pricing power but only has a low pricing risk.

Aggressive Increase 2536 indicates when the pricing is aggressive. Aggressive Increase 2536 typically occurs when the business segment has a high level of pricing power and a low pricing risk. Likewise, Moderate Increase 2538 indicates when the pricing is moderately increased. Moderate Increase 2538 typically occurs when the business segment has a high level of pricing power and a medium pricing risk.

Tighten Thresholds 2540 indicates when the pricing thresholds are tightened. Tighten Thresholds 2540 typically occurs when the business segment has a high level of pricing power and a high pricing risk.

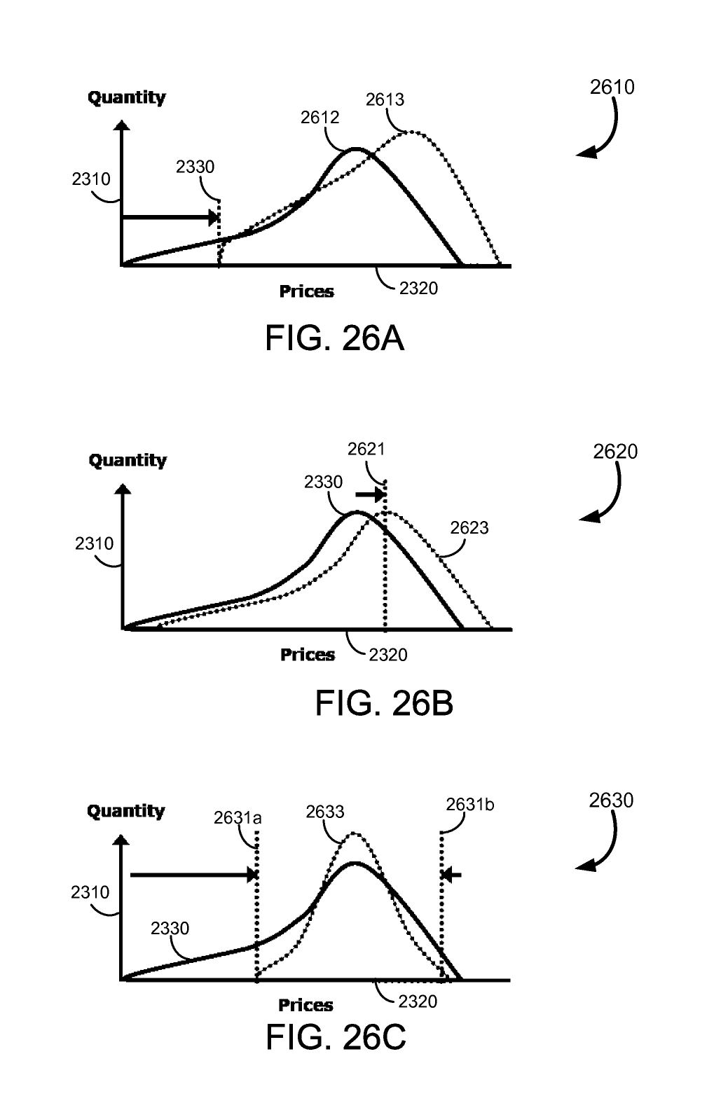

FIG. 26A is a graphical representation illustrating the ability to shape price distribution curves through eliminating low price deals, shown generally at 2610. Again, Sale Quantity Axis 2310, Pricing Axis 2320 and Historic Product Demand Curve 2330 may be seen. The elimination of low priced deals as indicated by 2611 may shift Historic Product Demand Curve 2330 to conform to Modified Demand Curve 2613 with no low priced deals.

FIG. 26B is a graphical representation illustrating the ability to shape price distribution curves through increasing average sales price, shown generally at 2620. Again, Sale Quantity Axis 2310, Pricing Axis 2320 and Historic Product Demand Curve 2330 may be seen. The increase in the average sales price is indicated by 2621 may shift Historic Product Demand Curve 2330 to conform to Modified Demand Curve 2623 with an increased average price.

FIG. 26C is a graphical representation illustrating the ability to shape price distribution curves through reducing price variation, shown generally at 2630. Again, Sale Quantity Axis 2310, Pricing Axis 2320 and Historic Product Demand Curve 2330 may be seen. The reduction in pricing variance indicated by 2631a and 2631b may shift Historic Product Demand Curve 2330 to conform to Modified Demand Curve 2633 with less variation in price.

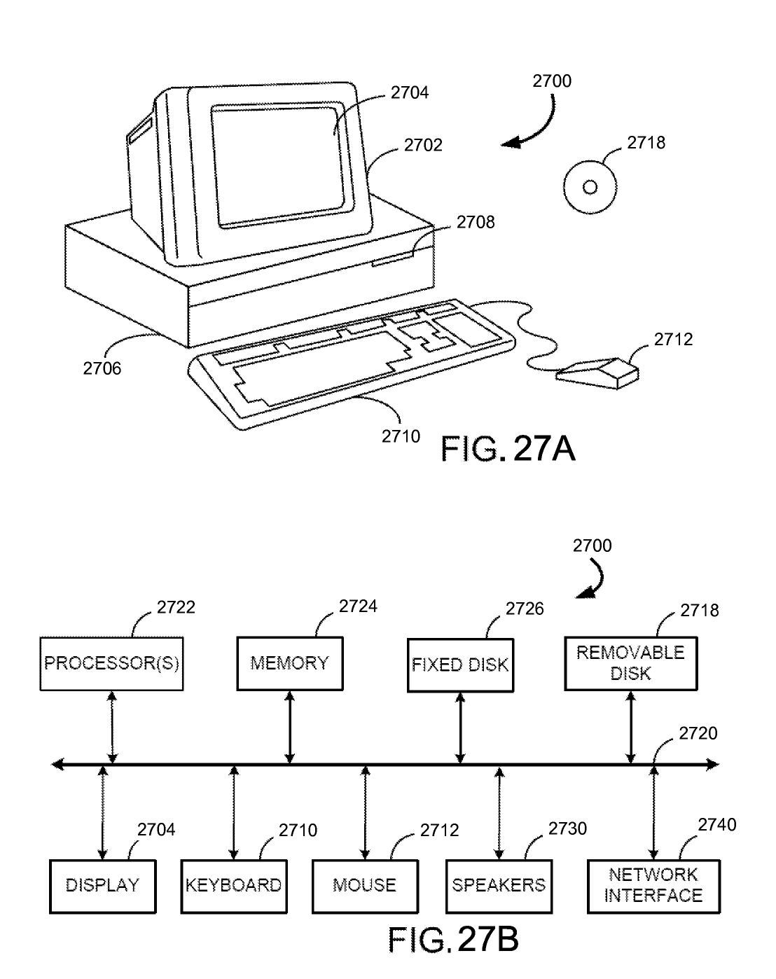

FIGS. 27A and 27B illustrate a Computer System 2700, which is suitable for implementing embodiments of the present invention. FIG. 27A shows one possible physical form of the Computer System 2700. Of course, the Computer System 2700 may have many physical forms ranging from a printed circuit board, an integrated circuit, and a small handheld device up to a huge super computer. Computer system 2700 may include a Monitor 2702, a Display 2704, a Housing 2706, a Disk Drive 2708, a Keyboard 2710, and a Mouse 2712. Disk 2718 is a computer-readable medium used to transfer data to and from Computer System 2700.

FIG. 27B is an example of a block diagram for Computer System 2700. Attached to System Bus 2720 are a wide variety of subsystems. Processor(s) 2722 (also referred to as central processing units, or CPUs) are coupled to storage devices, including Memory 2724. Memory 2724 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 2726 may also be coupled bi-directionally to the Processor 2722; it provides additional data storage capacity and may also include any of the computer-readable media described below. Fixed Disk 2726 may be used to store programs, data, and the like and is typically a secondary storage medium (such as a hard disk) that is slower than primary storage. It will be appreciated that the information retained within Fixed Disk 2726 may, in appropriate cases, be incorporated in standard fashion as virtual memory in Memory 2724. Removable Disk 2718 may take the form of any of the computer-readable media described below.

Processor 2722 is also coupled to a variety of input/output devices, such as Display 2704, Keyboard 2710, Mouse 2712 and Speakers 2730. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, or other computers. Processor 2722 optionally may be coupled to another computer or telecommunications network using Network Interface 2740. With such a Network Interface 2740, it is contemplated that the Processor 2722 might receive information from the network, or might output information to the network in the course of performing the above-described Price Optimization System with Business Segmentation 100. Furthermore, method embodiments of the present invention may execute solely upon Processor 2722 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as optical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

While this invention has been described in terms of several preferred embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

1. A computer implemented method for optimization of product prices using business segmentation, useful in association with a plurality of products, the method comprising:
segmenting a business into a plurality of selected segments, wherein each segment of the plurality of segments includes a subset of products from the plurality of products;
computing pricing power of each segment of the plurality of segments wherein the pricing power is an ability to alter pricing of the products within the segment;
computing pricing risk of each segment of the plurality of segments wherein the pricing risk is a risk factor associated with an alteration to pricing of the products within the segment;
generating pricing objectives for each segment by comparing the pricing power of the segment to the pricing risk of the segment;
optimizing prices for selected segments using the pricing objectives;
setting prices based on optimized prices;
managing price lists and policies;
negotiating prices based on optimized prices; and
linking price optimization system to an enterprise resource system.

2. The computer implemented method, as recited in claim 1, wherein segmenting the business into the plurality of selected segments utilizes fixed dimensions and variable dimensions.

3. The computer implemented method, as recited in claim 2, wherein fixed dimensions include at least one of geography, sales region, market group, customer size, customer type, industry, and deal type.

4. The computer implemented method, as recited in claim 2, wherein variable dimensions include at least one of customer class, product class, and deal class.

5. The computer implemented method, as recited in claim 4, wherein product class include at least one of measures and levels, wherein measures includes at least one of volume, revenue, profit, margin, net price, purchase frequency, discount rates, compliance rates and customer behavior, and wherein levels may include quality and status.

6. The computer implemented method, as recited in claim 1, wherein computing pricing power includes analyzing at least one of price variance, win rates, price yields and competitor pricing.

7. The computer implemented method, as recited in claim 1, wherein computing pricing risk includes analyzing at least one of sales revenue, sales trend, price distribution and customer spend.

8. The computer implemented method, as recited in claim 1, wherein generating pricing objectives includes performing a matrix analysis of pricing power and pricing risk.

9. A price optimization system using business segmentation, useful in association with a plurality of products, the price optimization system comprising:
a segmentor configured to segment a business into a plurality of selected segments, wherein each segment of the plurality of segments includes a subset of products from the plurality of products;
a pricing power engine configured to compute pricing power of each segment of the plurality of segments wherein the pricing power is an ability to alter pricing of the products within the segment;
a pricing risk engine configured to compute pricing risk of each segment of the plurality of segments wherein the pricing risk is a risk factor associated with an alteration to pricing of the products within the segment;
a pricing objective engine configured to generate pricing objectives for each segment by comparing the pricing power of the segment to the pricing risk of the segment;
an optimizer configured to optimize prices for selected segments using the pricing objectives;
a price setter configured to set prices based on optimized prices;
a manager configured to supervise price lists and policies;
a negotiator configured to negotiate prices based on optimized prices; and
a network connector configured to link price optimization system to an enterprise resource system.

10. The price optimization system of claim 9, wherein the segmentor is configured to segment the business into the plurality of selected segments by utilizing fixed dimensions and variable dimensions.

11. The price optimization system of claim 10, wherein fixed dimensions include at least one of geography, sales region, market group, customer size, customer type, industry, and deal type.

12. The price optimization system of claim 10, wherein variable dimensions include at least one of customer class, product class, and deal class.

13. The price optimization system of claim 12, wherein product class include at least one of measures and levels, wherein measures includes at least one of volume, revenue, profit, margin, net price, purchase frequency, discount rates, compliance rates and customer behavior, and wherein levels may include quality and status.

14. The price optimization system of claim 9, wherein pricing power engine is configured to compute pricing power by analyzing at least one of price variance, win rates, price yields and competitor pricing.

15. The price optimization system of claim 9, wherein pricing risk engine is configured to compute pricing risk by analyzing at least one of sales revenue, sales trend, price distribution and customer spend.

16. The price optimization system of claim 9, wherein pricing objective engine is configured to perform a matrix analysis of pricing power and pricing risk.

17. A computer implemented method for business segmentation, useful in association with a plurality of products, the method comprising:
receiving fixed dimensions;
receiving variable dimensions;
performing factor analysis on the fixed dimensions and variable dimensions;
performing cluster analysis on the fixed dimensions and variable dimensions;
performing correlation analysis on the fixed dimensions and variable dimensions; and
segmenting a business into a plurality of selected segments by balancing the results of the factor analysis, cluster analysis and correlation analysis, wherein each segment of the plurality of segments includes a subset of products from the plurality of products.

18. A computer implemented method for generating pricing objectives, useful in association with a plurality of products, the method comprising:
segmenting a business into a plurality of selected segments, wherein each segment of the plurality of segments includes a subset of products from the plurality of products;
computing pricing power of each segment of the plurality of segments wherein the pricing power is an ability to alter pricing of the products within the segment;
computing pricing risk of each segment of the plurality of segments wherein the pricing risk is a risk factor associated with an alteration to pricing of the products within the segment; and
generating pricing objectives for each segment by comparing the pricing power of the segment to the pricing risk of the segment.
